(19) United States
(12) Patent Application Publication
(10) Pub. No.: US 2024/0412046 A1
(43) Pub. Date: Dec. 12, 2024

(54) DATA CONVERSION APPARATUS, DATA CONVERSION METHOD, AND NON-TRANSITORY COMPUTER READABLE MEDIUM STORING PROGRAM

(71) Applicant: NEC Corporation, Minato-ku, Tokyo (JP)

(72) Inventor: Youki SADA, Tokyo (JP)

(73) Assignee: NEC Corporation, Minato-ku, Tokyo (JP)

(21) Appl. No.: 18/691,106

(22) PCT Filed: Sep. 28, 2021
(86) PCT No.: PCT/JP2021/035710

§ 371 Date: Mar. 12, 2024

(51) Int. Cl. G06N 3/0464

(52) U.S. Cl. CPC G06N 3/0464

(57) ABSTRACT

A new technology capable of processing a neural network including layers including MV products at a high speed is provided. A data conversion apparatus (1) includes a structural data acquisition unit (2) configured to acquire structural data representing a structure of a neural network, a node extraction unit (3) configured to extract a plurality of nodes for a matrix vector product from the structural data, a converting unit (4) configured to convert the extracted plurality of nodes into nodes in a convolutional layer, and a structural data output unit (5) configured to outputting the converted structural data.

### TECHNICAL FIELD

The present disclosure relates to a data conversion apparatus, a data conversion method, and a non-transitory computer readable medium storing program.

### BACKGROUND ART

The development of technologies for natural language processing, image recognition, and the like by using a deep neural network (DNN: Deep Neural Network) are being actively pursued. A convolutional neural network (CNN: Convolutional Neural Network) is often used in the field of image recognition in which still images are handled. Further, a recurrent neural network (RNN: Recurrent Neural Network) is often used in the field of image recognition and the field of natural language processing in both of which time series data such as moving images or voices are handled.

By training a DNN in a large-scale server by using a large amount of learning data, the DNN can achieve recognition higher than that achievable by non-DNN methods. However, according to the inference using DNNs, it is necessary to carry out processing in real-time under an environment in which an amount of electric power is limited such as in an edge device and a mobile terminal. ASIC (Application Specific Integrated Circuit) devices are attracting attention as hardware capable of efficiently carrying out a DNN under such an environment. An ASIC device equipped with a dedicated convolutional circuit has power efficiency superior to that of general-purpose GPUs (Graphics Processing Units) and CPUs (Central Processing Units).

Non-Patent Literature 1 proposes a systolic array for an RNN. A technology disclosed in this literature reduces the number of memory accesses for weights by changing the calculation order in MV products (Matrix Vector products) at two time points, i.e., at a time t and a time t+1 adjacent to each other, and by doing so, has successfully speeded up the processing by a factor of 2.1 compared to the case where this technology is not used. Further, a technology disclosed in Non-patent Literature 2 reduces the number of product-sum operations by skipping multiplications of weights by zero values of vector elements, and by doing so, has successfully speeded up the processing. Further, each of Non-patent Literature 3 and Non-patent Literature 4 reported the speedup of operations in RNN layers in general-purpose GPUs or CPUs.

### CITATION LIST

### Non Patent Literature

Non-patent Literature 1: Naebeom Park et al., “Time-Step Interleaved Weight Reuse for LSTM Neural Network Computing”, ISLPED 2020.
Non-patent Literature 2: Chang Gao et al., “DeltaRNN: A Power-efficient Recurrent Neural Network Accelerator”, FPGA 2018.
Non-patent Literature 3: Connor Holmes et al., “GRNN: Low-Latency and Scalable RNN Inference on GPUs”, EuroSys 2019.
Non-patent Literature 4: Minjia Zhang et al., “DeepCPU: Serving RNN-based Deep Learning Models 10× Faster”, USENIX ATC 2018.

### SUMMARY OF INVENTION

### Technical Problem

For example, it is necessary to carry out a huge number of processes in RNN layers or FC layers (Fully Connected layers) in RNNs. Since an RNN layer and an FC layer consist of MV products, it is necessary to speed up the calculation of MV products in order to process the neural network including these layers in real time.

The problem is that the efficiency of the execution of MV products in existing ASIC devices and GPUs for neural networks is worse than that of MM products (Matrix Matrix products), so it is difficult to carry out a large number of MV products at a high speed. Most of existing GPUs and ASIC devices are tailored to MM products, in which it is assumed that an input is a sufficiently large matrix, and they are designed so that the time required to access a memory in order to refer to weights is sufficiently smaller than the time required for product-sum operations of an input matrix and the weights. The MV product is a small 1D (one-dimensional) vector of which the input data is different from that of the MM product. Therefore, the time required for a memory access for a weight matrix, which memory access frequently occurs, is longer than the time required for a product-sum operation of an input vector and a weight matrix.

The above-described Non-patent Literatures 1 and 2 propose circuits dedicated to RNNs and cannot be applied to widely used devices for DNNs. Further, since the circuits disclosed in these literatures are circuits dedicated to RNN layers, they cannot be implemented for FC layers or convolutional layers without making additional circuit modifications. Further, Non-patent Literatures 3 and 4 reported the speedup of operations in RNN layers in general-purpose GPUs or CPUs. However, these studies are for a speedup method (e.g., tiling on a device) for servers having large power consumption and including large memories. Therefore, it is difficult to apply such a speedup method to ASIC devices which receive only instructions for carrying out basic convolutional layers or FC layers, and in which it is difficult to handle delicate instructions such as the control of a memory.

In view of the above-described background, there is still a need for a technology for processing a neural network including layers including MV products at a high speed. Therefore, an object of an example embodiment disclosed in the specification of the present application is to provide a new technology capable of processing a neural network including layers including MV products at a high speed.

### Solution to Problem

A data conversion apparatus according to a first aspect of the present disclosure includes:
structural data acquisition means for acquiring structural data representing a structure of a neural network;
node extraction means for extracting a plurality of nodes for a matrix vector product from the structural data;
conversion means for converting the extracted plurality of nodes into nodes in a convolutional layer; and
structural data output means for outputting the converted structural data.

A data conversion method according to a second aspect of the present disclosure includes:
acquiring structural data representing a structure of a neural network; extracting a plurality of nodes for a matrix vector product from the structural data;
converting the extracted plurality of nodes into nodes in a convolutional layer; and
outputting the converted structural data.

A program according to a third aspect of the present disclosure causes a computer to perform:
a step of acquiring structural data representing a structure of a neural network;
a step of extracting a plurality of nodes for a matrix vector product from the structural data;
a step of converting the extracted plurality of nodes into nodes in a convolutional layer; and
a step of outputting the converted structural data.

### Advantageous Effects of Invention

According to the present disclosure, it is possible to provide a new technology capable of processing a neural network including layers including MV products at a high speed.

### BRIEF DESCRIPTION OF DRAWINGS

FIG. 1 is a schematic diagram for explaining a method for calculating a convolutional layer;

FIG. 2 is a schematic diagram for explaining a method for calculating an FC layer:

FIG. 3 is a block diagram showing an example of a configuration of a data conversion apparatus according to a first example embodiment:

FIG. 4 is a table showing an example of structural data of a neural network including two FC layers:

FIG. 5 is a schematic diagram showing a connection relationship of nodes represented by the structural data shown in FIG. 4:

FIG. 6 is a table showing an example of a neural network structural data including two RNN layers (LSTM layers):

FIG. 7 is a schematic diagram showing a connection relationship of nodes represented by the structural data shown in FIG. 6:

FIG. 8 is a table showing an example of structural data representing a structure of a neural network after a dividing process is performed on a neural network represented by the structural data shown in FIG. 6:

FIG. 9 is a schematic diagram showing a connection relationship of nodes represented by the structural data shown in FIG. 8:

FIG. 10 is a table showing an example of structural data generated by an MV product conversion unit for a neural network from which a set consisting of two FC layers is extracted:

FIG. 11 is a schematic diagram showing a connection relationship of nodes represented by the structural data shown in FIG. 10;

FIG. 12 is a table showing an example of structural data generated by an MV product conversion unit for a neural network from which a set consisting of two LSTM layers is extracted:

FIG. 13 is a schematic diagram showing a connection relationship of nodes represented by the structural data shown in FIG. 12:

FIG. 14 is a flowchart showing an example of operations performed by the data conversion apparatus according to the first example embodiment:

FIG. 15 is a block diagram showing an example of a hardware configuration of the data conversion apparatus according to the first example embodiment:

FIG. 16 is a schematic diagram showing an example of a structure of a neural network including a first set of FC layers and a second set of FC layers connected in series with the first set:

FIG. 17 is a schematic diagram showing an example of a structure converted from the structure shown in FIG. 16; and

FIG. 18 is a block diagram showing an example of a configuration of a data conversion apparatus according to a second example embodiment.

### EXAMPLE EMBODIMENT

Prior to describing an example embodiment, an explanation for facilitating the understanding of the example embodiment will be given.

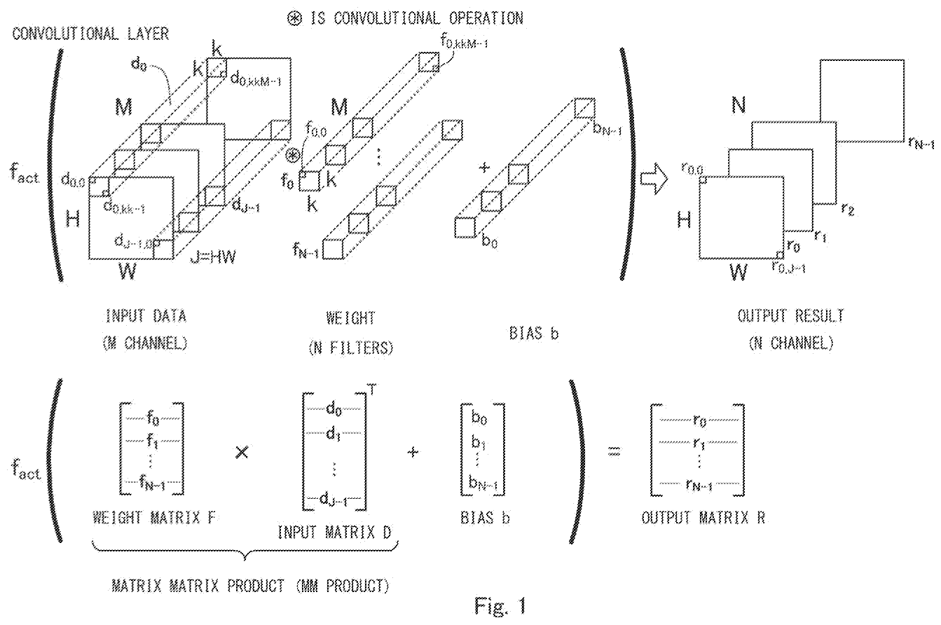

Convolutional layers and fully connected layers (FC layers) are mainly included in a CNN. Further, RNN layers and FC layers are included in an RNN. Firstly, a method for calculating a convolutional layer will be described with reference to FIG. 1.

FIG. 1 is a schematic diagram for explaining a method for calculating a convolutional layer. In this example, in order to simplify the explanation, a simple case in which a batch size is one, the height of input data and the height of output data are equal to each other and represented by H, and their widths are equal to each other and represented by W will be explained. Note that M is the number of channels of input data: N is the number of channels of output data: k is a kernel size; and b is a bias value. As shown in an upper part of FIG. 1, in the calculation of a convolutional layer, a convolution of N weight filters and input data is calculated. Then, a bias value is added to the result of the calculation, and a non-linear activation function fact is applied thereto.

Meanwhile, the execution of a convolution of 3D (three-dimensional) input data and 3D weights is complicated. Therefore, in general, the convolution is carried out by converting the input data and the weights into 2D (two-dimensional) matrices and calculating the matrix product (MM product) of the 2D matrices. As shown in a lower part in FIG. 1, a convolutional layer can be expressed by the addition of the MM product of a 2D input matrix D and a 2D weight matrix F and a bias value, and the calculation of the non-linear activation function fact. The input matrix D is expressed as D [i][j]=d_{i,j} by using the below-shown vector in which only a part of the input data ((number of channels, number of columns, and number of rows)=(M, k, k)) is cut out and arranged in one dimension. dₗ=(d_{l,0} . . . d_{l,kkM-1}), l=0, . . . , J−1, J=H·W Similarly, the weight matrix F is expressed as F[i][j]=f_{i,j} by using the below-shown vector in which weight filters are arranged in one dimension.

fₗ=(f_{l,0}. . . f_{l,kkM-1}),l=0, . . . ,N−1

Further, the output matrix R is expressed as R [i] [j]=rij by using the below-shown vector.

rₗ=(r_{l,0}. . . r_{l,j-1})

The convolutional layer can be defined, by using the above-described input matrix D, the weight matrix F, the below-shown bias value, b=(b₀ . . . b_{N-1}) and the non-linear activation function fact, by the below-shown Expression (1). Note that, in general, a ReLU (Rectified Linear Unit) function is used for the non-linear activation function f_{act}.

$$R [ j ] [ l ] = {f}_{act} ( {\sum }_{n = 0}^{kkM - 1} F [ j ] [ n ] \cdot D [ l ] [ n ] + b [ j ] ) , \\ j = 0 , … , N - 1 , l = 0 , … , J - 1 \qquad 〈 Expression ( 1 ) 〉$$

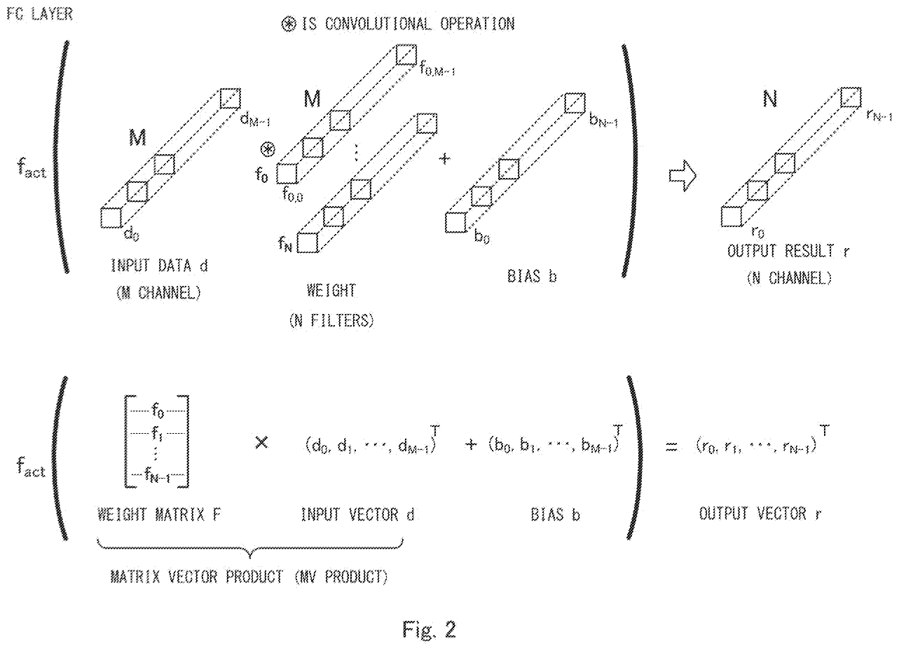

Next, an FC layer will be described with reference to FIG. 2. FIG. 2 is a schematic diagram for explaining a method for calculating an FC layer. As shown in an upper part of FIG. 2, in the calculation of an FC layer, a convolution of 2D weights and 1D (one-dimensional) input vector d is calculated. Then, a bias is added to the result of the calculation, and a non-linear activation function fact is applied thereto. The convolution in the FC layer is equivalent to the matrix vector product (MV product). The FC layer is expressed by the below-shown Expression (2) by using the input vector d, the weight matric F, the bias value b, and the non-linear activation function fact (see a lower part in FIG. 2). Note that d [i] is an i-th element dᵢ of the input vector, and r [i] is an i-th element rᵢ of the output vector.

$$r [ j ] = {f}_{act} ( {\sum }_{n = 0}^{M - 1} F [ j ] [ n ] \cdot d [ n ] + b [ j ] ) , j = 0 , … , N - 1 \qquad 〈 Expression ( 2 ) 〉$$

Next, an LSTM layer (Long short-term memory layer), which is a type of RNN layer, will be described. The LSTM layer is expressed by the below-shown Expressions (3) to (5).

$${g}_{i , t} [ j ] = {\sum }_{n = 0}^{P - 1} {F}_{i} [ j ] [ n ] \cdot {x}_{t} [ n ] + {\sum }_{n = 0}^{Q - 1} {G}_{i} [ j ] [ n ] \cdot {h}_{t - 1} [ n ] + {b}_{i} [ j ] \qquad 〈 Expression ( 3 ) 〉$$

$${c}_{t} [ j ] = σ ( {g}_{0 , t} [ j ] ) \cdot {c}_{t - 1} [ j ] + σ ( {g}_{1 , t} [ j ] ) \cdot tanh ( {g}_{2 , t} [ j ] ) \qquad 〈 Expression ( 4 ) 〉$$

$${h}_{t} [ j ] = tanh ( {c}_{t} [ j ] ) \cdot σ ( {g}_{3 , t} [ j ] ) , \\ j = 0 , … , Q - 1 , i = 0 , … , 3 \qquad 〈 Expression ( 5 ) 〉$$

In the expressions, P is the number of elements in an input vector x; Q is the number of elements in an output vector h; and b is a bias value. In the LSTM layer, a sum g_{i,t} of an MV product of an input weight Fᵢ and an input vector xₜ at a time t, an MV product of a recurrent weight Gᵢ and an output vector hₜ₋₁ at a time t−1, and a bias bi is calculated for i=0, . . . , 3. Further, an output vector hₜ is calculated by performing element operation for g_{0,t} to g_{3,t}. Note that the element operation is an operation performed independently for each element of a tensor, and refers to an operation other than the MV product and the MM product. In the case of the LSTM layer, a sigmoid function σ, a hyperbolic tangent function tanh, products for respective elements, and sums for respective elements correspond to the element operation. Further, initial values of an internal state cₜ and an output vector hₜ are c₀[j]=0 and h₀[j]=0, respectively, for j=0, . . . , and Q−1.

Note that the calculation of the LSTM layer in Expression (3) can be expressed by the below-shown Expression (7) by using a matrix F_{cat} having 4Q rows and P+Q columns obtained by connecting input weights F₀, . . . , and F₃ and recurrent weights G₀, . . . , and G₃, a vector x′ₜ having P+Q elements (i.e., P+Q pieces of elements), which is obtained by connecting the vector xₜ and the vector hₜ₋₁, and a vector b′ obtained by connecting bias value b₀ to b₃. Note that the matrix F_{cat}, the vector x′ₜ, and the vector b′ are expressed by the below-shown Expression (6).

$${F}_{cat} = [ \begin{matrix}{F}_{0} & {G}_{0} \\ {F}_{1} & {G}_{1} \\ {F}_{2} & {G}_{2} \\ {F}_{3} & {G}_{3}\end{matrix} ] = [ \begin{matrix}{F}_{0} [ 0 ] [ 0 ] & … & {F}_{0} [ 0 ] [ P - 1 ] & {G}_{0} [ 0 ] [ 0 ] & … & {G}_{0} [ 0 ] [ Q - 1 ] \\ ⋮ & ⋱ & ⋮ & ⋮ & ⋱ & ⋮ \\ {F}_{0} [ Q - 1 ] [ 0 ] & … & {F}_{0} [ Q - 1 ] [ P - 1 ] & {G}_{0} [ Q - 1 ] [ 0 ] & … & {G}_{0} [ Q - 1 ] [ Q - 1 ] \\ {F}_{1} [ 0 ] [ 0 ] & … & {F}_{1} [ 0 ] [ P - 1 ] & {G}_{1} [ 0 ] [ 0 ] & … & {G}_{1} [ 0 ] [ Q - 1 ] \\ ⋮ & ⋱ & ⋮ & ⋮ & ⋱ & ⋮ \\ {F}_{1} [ Q - 1 ] [ 0 ] & … & {F}_{1} [ Q - 1 ] [ P - 1 ] & {G}_{1} [ Q - 1 ] [ 0 ] & … & {G}_{1} [ Q - 1 ] [ Q - 1 ] \\ {F}_{2} [ 0 ] [ 0 ] & … & {F}_{2} [ 0 ] [ P - 1 ] & {G}_{2} [ 0 ] [ 0 ] & … & {G}_{2} [ 0 ] [ Q - 1 ] \\ ⋮ & ⋱ & ⋮ & ⋮ & ⋱ & ⋮ \\ {F}_{2} [ Q - 1 ] [ 0 ] & … & {F}_{2} [ Q - 1 ] [ P - 1 ] & {G}_{2} [ Q - 1 ] [ 0 ] & … & {G}_{2} [ Q - 1 ] [ Q - 1 ] \\ {F}_{3} [ 0 ] [ 0 ] & … & {F}_{3} [ 0 ] [ P - 1 ] & {G}_{3} [ 0 ] [ 0 ] & … & {G}_{3} [ 0 ] [ Q - 1 ] \\ ⋮ & ⋱ & ⋮ & ⋮ & ⋱ & ⋮ \\ {F}_{3} [ Q - 1 ] [ 0 ] & … & {F}_{3} [ Q - 1 ] [ P - 1 ] & {G}_{3} [ Q - 1 ] [ 0 ] & … & {G}_{3} [ Q - 1 ] [ Q - 1 ]\end{matrix} ] \qquad 〈 Expression ( 6 ) 〉$$

$${x}_{t}^{′} = ( \begin{matrix}{x}_{t} & {h}_{t - 1} ) = ( {x}_{t} [ 0 ] , … , {x}_{t} [ P - 1 ] , {h}_{t - 1} [ 0 ] , … , {h}_{t - 1} [ Q - 1 ] )\end{matrix}$$

$${b}^{′} = ( \begin{matrix}{b}_{0} & {b}_{1} & {b}_{2} & {b}_{3}\end{matrix} )$$

$${m}_{t} [ j ] = {\sum }_{n = 0}^{P + 1 - 1} ( [ {F}_{cat} [ j ] [ n ] \cdot {x}_{t}^{′} [ n ] ) + {b}^{′} [ j ] , j = 0 , … , 4 Q - 1 \qquad 〈 Expression ( 7 ) 〉$$

$${g}_{i , t} [ j ] = {m}_{t} [ j + iQ ] , i = 0 , … , 3 , j = 0 , … , Q - 1$$

Further, Expressions (4) and (5) are expressed by the below-shown Expression (8).

$${c}_{t} [ j ] = {f}_{ew 1} ( {g}_{0 , t} [ j ] , {g}_{1 , t} [ j ] , {g}_{2 , t} [ j ] , {c}_{t - 1} [ j ] ) \qquad 〈 Expression ( 8 ) 〉$$

$${h}_{t} [ j ] = {f}_{ew 2} ( {g}_{3 , t} [ j ] , {c}_{t} [ j ] ) , j = 0 , … , Q - 1$$

Note that the element operations f_{ew1} and f_{ew2} are defined by the below-shown Expression (9).

$${f}_{ew 1} ( {a}_{0} , {a}_{1} , {a}_{2} , {a}_{3} ) = σ ( {a}_{0} ) \cdot {a}_{3} + σ ( {a}_{1} ) \cdot tanh ( {a}_{2} ) , \\ {a}_{0} , {a}_{1} , {a}_{2} , {a}_{3} ∈ ℝ \qquad 〈 Expression ( 9 ) 〉$$

$${f}_{ew 2} ( {a}_{0} , {a}_{1} ) = tanh ( {a}_{1} ) \cdot σ ( {a}_{0} ) , {a}_{0} , {a}_{1} ∈ ℝ$$

The execution time of the element operations f_{ew1} and f_{ew2} is shorter than that of the MV products, and most of the execution time of the RNN is occupied (i.e., required) by the MV products. Therefore, in order to process the RNN in real time, there is a need for a method for speeding up the MV products. Note that although the calculation of an LSTM layer is described as an example of the calculation of an RNN layer in this specification, it does not mean that the invention is not applicable to other types of RNN layers such as a GRU (Gated Recurrent Unit) layer. Other RNN layers can also be expressed by using MV products and element operations, and the present invention is also applicable to these RNN layers.

An example embodiment will be described hereinafter. In the example embodiment, the structural data of a neural network including layers including MV products is converted so that the calculation of MM products can be applied thereto. In this way, it is possible to process this neural network at a high speed in devices such as CPUs, GPUs, and ASICs.

### First Example Embodiment

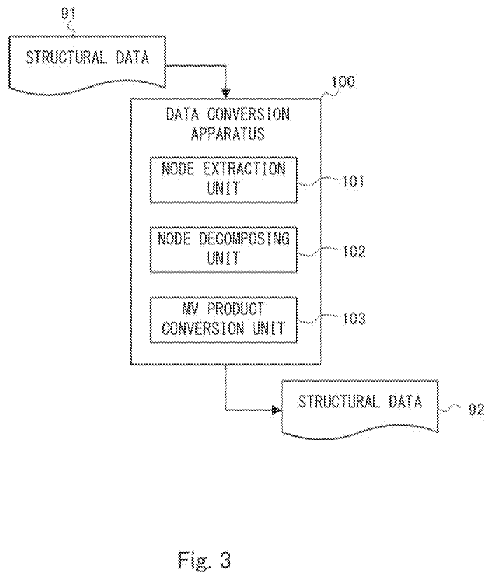

FIG. 3 is a block diagram showing an example of a configuration of a data conversion apparatus 100 according to a first example embodiment. As shown in FIG. 3, the data conversion apparatus 100 includes a node extraction unit 101, a node decomposing unit 102, and an MV product conversion unit 103. The data conversion apparatus 100 performs, for input structural data 91, a conversion process for carrying out the calculation of MV products by performing the calculation of MM products, and outputs converted structural data 92.

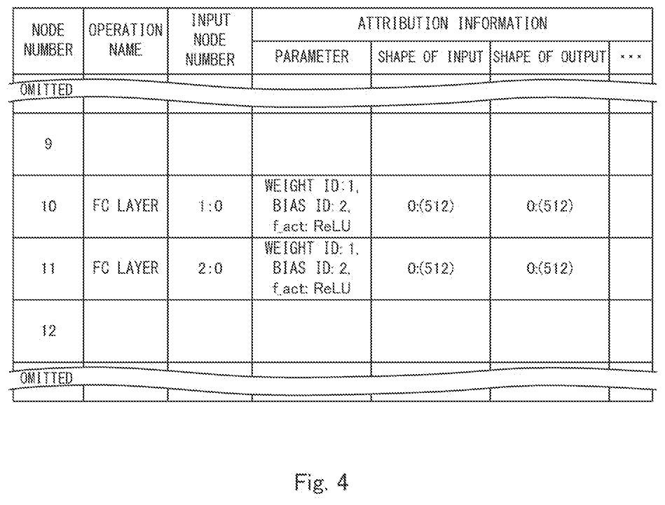

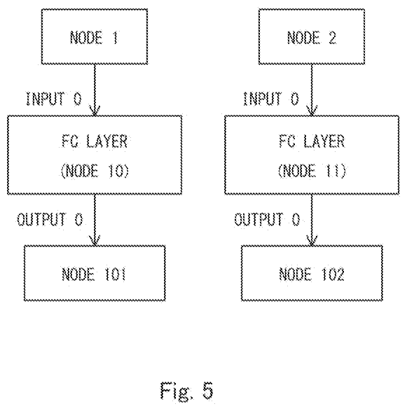

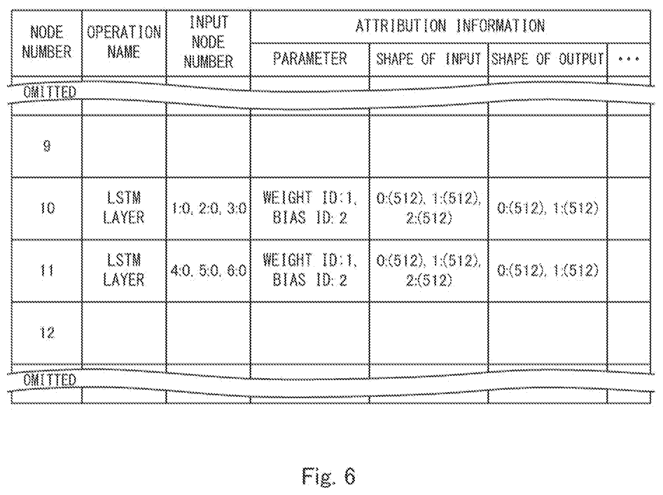

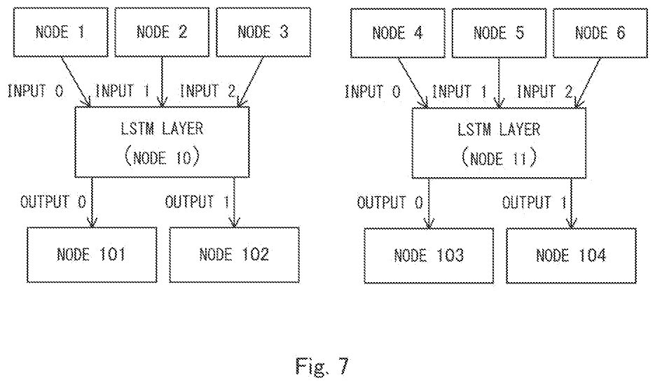

Note that the structural data is data representing the structure of a neural network, and specifically, data defining a connection relationship between nodes of the neural network and the details of processing at each node. FIG. 4 shows an example of structural data of a neural network including two FC layers. FIG. 5 is a schematic diagram showing a connection relationship of nodes represented by the structural data shown in FIG. 4. Further, FIG. 6 shows an example of structural data of a neural network including two RNN layers (LSTM layers). FIG. 7 is a schematic diagram showing a connection relationship of nodes represented by the structural data shown in FIG. 6. Three inputs (Input 0, Input 1, and Input 2) of nodes in the LSTM layer shown in FIG. 7 represent an input vector xₜ, an output vector hₜ₋₁, and an internal state cₜ₋₁ at an immediately previous time, respectively, and two outputs (Output 0 and Output 1) represent an output vector hₜ and an internal state cₜ, respectively.

Specifically, as shown in FIGS. 4 and 6, the structural data of the neural network is expressed by a table including a plurality of nodes, and has the following information for each data. That is, the structural data includes a node number, which is an identifier of a node, an operator name, an input node number, and attribute information, which is additional information that is referred to for an operation or the like. Note that in the following description, a node having a node number i (note that i is an index number indicating a node number) may also be expressed as a node i. For example, a node having a node number 10 is expressed as a node 10.

The operator name is information for specifying an operation to be performed at the node, and indicates the type of operation to be used at the node. Before an arbitrary device that processes the neural network actually performs the processing based on the structural data, the operator name in the structural data is read out and the read operator name is converted to machine language corresponding to the operator name. The conversion of the structural data by the data conversion apparatus 100 is a highly-abstract deformation of a neural network structure, and does not change the actual operator itself. Therefore, the result of the conversion by the data conversion apparatus 100 can be applied to a device using completely different machine language, such as a CPU, a GPU, an ASIC, or the like.

The input node number indicates a connection relationship on the input side. Specifically, the input node number is information indicating, for each input to the node, which output of which node. For example, when the input node number shown in the structural data is “x1:y1, x2: y2”, it indicates that the 0-th input is connected to a y1-th output of a node having a node number x1, and the first input is connected to a y2-th output of a node having a node number x2.

The attribute information includes parameters, the shape of the input, and the shape of the output. The parameters in the attribute information indicate parameters necessary during the operation, such as weights, a bias value, and a kernel size (when an operation in a convolutional layer is performed). That is, the parameters in the attribute information are parameters for the operation. Specifically, for example, weight IDs and bias value IDs shown in FIGS. 4 and 6 are pointer addresses of files or memories in which weight parameters F, the matrix F_{cat}, or bias parameters b and b′ are stored, and are referred to when the LSTM layer or FC layer is actually calculated in the device. Further, a parameter f_act shown in FIG. 4 indicates the type of the activation function.

The shape of inputs indicates the shape of data input to the node, and the shape of outputs indicates the shape of data output from the node. Note that the shape of data input or output is the shape of data as a tensor. The shape of inputs in the attribute information is information indicating, for each input to the node, the shape of data for the input, and the shape of outputs in the attribute information is information indicating, for each output from the node, the shape of data for the output. For example, when the shape of inputs (outputs) shown in the structural data is “x′: y′”, it indicates that the shape of data for an x′-th input (output) of the node is y′. How to express the shape in this paper will be described hereinafter. In this paper, “(x′)” represents a vector having x′ elements (i.e., x′ pieces of elements): “(y′, x′)” represents a 2D matrix having y′ rows and x′ columns; and “(z′, y′, x′)” represents a tensor having z′ channels, a height y′, and a width x′. For example, a shape “0:(512)” of an input shown in FIG. 4 indicates that the 0-th input is a 1D vector having 512 elements.

The node extraction unit 101 is a node for matrix vector products, and extracts a plurality of nodes that satisfy predetermined conditions from the input structural data 91. Specifically, the node extraction unit 101 extracts one set consisting of 2 or more RNN layers (or FC layers) that satisfy all of the below-shown three conditions. That is, the node extraction unit 101 extracts a set consisting of a plurality of RNN layers satisfying the below-shown Conditions 1 to 3. Alternatively, the node extraction unit 101 extracts a set consisting of a plurality of FC layers satisfying the below-shown Conditions 1 to 3.

Condition 1: Each RNN layer (or FC layer) of the set has an equal number of elements of input vectors corresponding to each other, and has an equal number of elements of output vectors corresponding to each other. Note that the input vectors (output vectors) corresponding to each other means an i-th input vector (output vector) in the first RNN layer (FC layer) and an i-th input vector (output vector) in the second RNN layer (FC layer). Note that when the input to the RNN layer (FC layer) is multidimensional data such as a matrix, Condition 1 requires that, for each dimension, the numbers of elements in that dimension be equal to each other.

Condition 2: Each RNN layer (or FC layer) of the set has equal weights and equal bias values used in the RNN layer (or FC layer).

Condition 3: Each RNN layer (or FC layer) of the set has no input/output dependency on each other.

In the example shown in FIG. 4, two FC layers (Nodes 10 and 11) in which the numbers of elements of the corresponding inputs/outputs are equal to each other (i.e., Condition 1 is satisfied), and the same weight (ID: 1) and the same bias (ID: 2) are used (i.e., Condition 2 is satisfied) are extracted. Similarly, in the example shown in FIG. 6, two LSTM layers (Nodes 10 and 11) in which the numbers of elements of the corresponding inputs/outputs are equal to each other (i.e., Condition 1 is satisfied), and in which the same weight (ID: 1) and the same bias (ID: 2) are used (i.e., Condition 2 is satisfied) are extracted. However, in each of the examples shown in FIGS. 4 and 6, it is assumed that Nodes 10 and 11 satisfy the above-described Condition 3.

Condition 3 is a condition that requires that the outputs of any of the extracted nodes are not connected directly or indirectly to the inputs of any of the other extracted nodes. The node extraction unit 101 recursively repeats, for each of the nodes satisfying Conditions 1 and 2, a search for a child node, and thereby confirms that it is not connected to the inputs of any of the other nodes satisfying Conditions 1 and 2. For example, the node extraction unit 101 searches child nodes, grandchild nodes, and the like of Node 10, and thereby confirms that the outputs of Node 10 are not connected to the inputs of Node 11. Similarly, the node extraction unit 101 searches child nodes, grandchild nodes, and the like of Node 11, and thereby confirms that the outputs of Node 11 are not connected to the inputs of Node 10. When the node extraction unit 101 confirms that the node satisfying Conditions 1 and 2 is not connected to the inputs of any of the other node satisfying Conditions 1 and 2, it determines that this node satisfies Conditions 3.

An FC layer that satisfies Conditions 1 and 2 satisfies the below-shown Expression (10). That is, the node extraction unit 101 extracts L nodes (L is an integer equal to or greater than 2, and in the example shown in FIG. 4, is equal to 2 (L=2)) in the FC layer that satisfy Expression (10).

$${r}_{l} [ j ] = {f}_{act} ( {\sum }_{n = 0}^{M - 1} F [ j ] [ n ] \cdot {d}_{l} [ n ] + b [ j ] ) , \\ j = 0 , … , N - 1 , l = 0 , … , L - 1 \qquad 〈 Expression ( 10 ) 〉$$

In the expression, dₗ and r₁ are an input vector d and an output vector r, respectively, of a node specified by an index 1 (l represents 1 in an alphabet). In Expression (10), the number of elements of the input vector dₗ is a number M that is common to all the extracted nodes (in the example shown in FIG. 4, l=0, 1), and the number of elements of the output vector rₗ is a number N that is common to all the extracted nodes. This fact corresponds to the fact that Condition 1 is satisfied. Further, in Expression (10), the weight matrix F and the bias value b used in the extracted nodes are the same (i.e., unchanged) irrespective of l. This fact corresponds to the fact that Condition 2 is satisfied.

An RNN layer (LSTM layer) that satisfies Conditions 1 and 2 satisfies the below-shown Expressions (11) to (15). That is, the node extraction unit 101 extracts L nodes in the RNN layer that satisfy these expressions (in the example shown in FIG. 6, L=2).

$${x}_{l , t}^{′} = ( \begin{matrix}{x}_{l , t} , & {h}_{l , t - 1}\end{matrix} ) = ( {x}_{l , t} [ 0 ] , … , {x}_{l , t} [ P - 1 ] , {h}_{l , t - 1} [ 0 ] , … , {h}_{l , t - 1} [ Q - 1 ] ) \qquad 〈 Expression ( 11 ) 〉$$

$${m}_{l , t} [ j ] = {\sum }_{n = 0}^{P + Q - 1} {F}_{cat} [ j ] [ n ] \cdot {x}_{l , t}^{′} [ n ] + {b}^{′} [ j ] , \\ j = 0 , … , 4 Q - 1 , l = 0 , … , L - 1 \qquad 〈 Expression ( 12 ) 〉$$

$${g}_{i , l , t} [ j ] = {m}_{l , t} [ j + iQ ] , i = 0 , … , 3 , \\ j = 0 , … , Q - 1 , l = 0 , … , L - 1 \qquad 〈 Expression ( 13 ) 〉$$

$${c}_{l , t} [ j ] = {f}_{ew 1} ( {g}_{0 , l , t} [ j ] , {g}_{1 , l , t} [ j ] , {g}_{2 , l , t} [ j ] , {c}_{l , t - 1} [ j ] ) , \\ j = 0 , … , Q - 1 , l = 0 , … , L - 1 \qquad 〈 Expression ( 14 ) 〉$$

$${h}_{l , t} [ j ] = {f}_{ew 2} ( {g}_{3 , l , t} [ j ] , {c}_{l , t} [ j ] ) , \\ j = 0 , … , Q - 1 , l = 0 , … , L - 1 \qquad 〈 Expression ( 15 ) 〉$$

In the expressions, x_{l,t}, hit, and c_{l,t} represent an input vector xₜ, an output vector hₜ, and an internal state cₜ, respectively, of a node specified by the index 1. Further, x′_{l,t}, m_{l,t}, and gilt are vectors for storing temporary calculation results during the calculation process; x′_{l,t} is a vector connecting the input vector and the output vector; m_{l,t} is the result of the calculation of the product-sum operation and the bias addition; and g_{0,l,t} to g_{3,l,t} are vectors obtained by dividing the result m_{l,t} into vectors each having Q elements (i.e., q pieces of elements). In these expressions, the number of elements of the input vector x_{l,t} of the node is a number P that is common to all the extracted nodes (in the example shown in FIG. 6, l=0, 1). Further, the number of elements of the input vector h_{l,t-1} of the node is a number Q that is common to all the extracted nodes. Further, the number of elements of the input vector c_{l,t} of the node is the number Q that is common to all the extracted nodes. Further, the number of elements of the output vector h_{l,t} of the node is the number Q that is common to all the nodes. These facts correspond to the fact that Condition 1 is satisfied. Further, the weight matrix F_{cat} used in the extracted nodes and the bias value b′ are the same (i.e., unchanged) irrespective of l. This fact corresponds to the fact that Condition 2 is satisfied.

When nodes in the RNN layer are extracted by the node extraction unit 101, the node decomposing unit 102 decomposes the extracted nodes in the RNN layer into nodes of a first type which are nodes of a matrix vector product and nodes of a second type which are nodes other than the matrix vector product. That is, when the L nodes extracted by the node extraction unit 101 are nodes in the RNN layer, the node decomposing unit 102 performs a node decomposing process in the RNN layer (which will be described below). Therefore, when the node extraction unit 101 extracts nodes in the fully connected layer (FC layer), the node decomposing unit 102 may be omitted (i.e., may not be necessary) in the data conversion apparatus 100.

As the node decomposing process, the node decomposing unit 102 performs a process for decomposing each of nodes in a plurality of RNN layers that satisfy the above-described Conditions 1 to 3 into nodes of MV products (first type nodes) and other calculation nodes (second type nodes). The number of nodes after the node decomposing process and the operator name change depending on the type of RNN layers. In the case of the LSTM layer, each node extracted by the node extraction unit 101 is decomposed into nodes of MV products expressed by Expression (12) and nodes of the other operation (element operation) expressed by Expression (11) and Expressions (13) to (15). Note that the operation expressed by Expression (12) is the same as the operation in the FC layer when an identity function is used as the function fact. Therefore, it can be described that the node decomposing unit 102 decomposes nodes extracted by the node extraction unit 101 into nodes for which the element operation is performed and those in the fully connected layer using the identity function as the non-linear activation function.

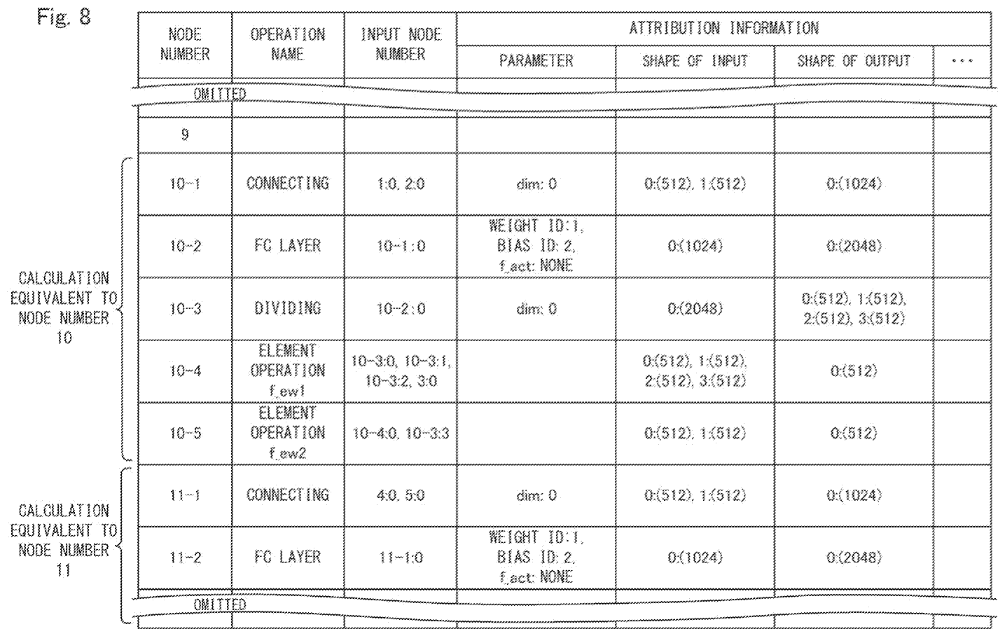

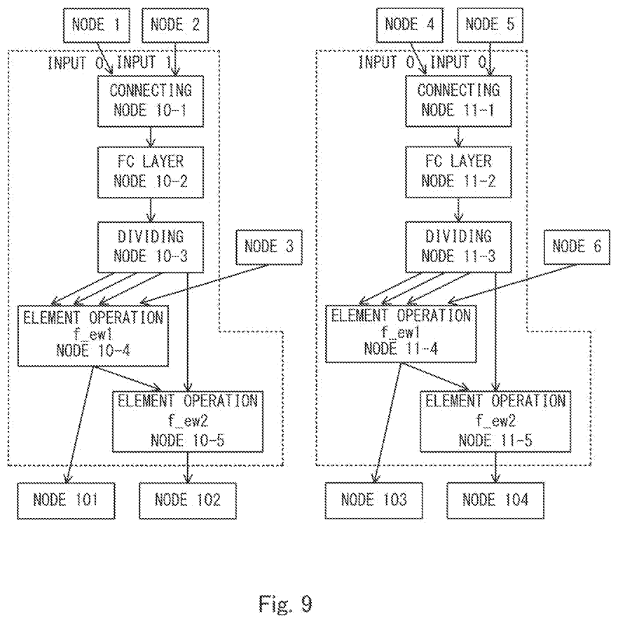

The node decomposing unit 102 generates, from the input structural data 91, structural data representing the structure of the neural network obtained after the decomposing process. FIG. 8 shows an example of structural data representing the structure of the neural network obtained after performing the decomposing process for the neural network represented by the structural data shown in FIG. 6. Further, FIG. 9 is a schematic diagram showing a connection relationship of nodes represented by the structural data shown in FIG. 8. Note that the numbers assigned to new nodes obtained by the decomposition are selected so as to be different from any of the numbers assigned to the other nodes.

The connecting process performed at Nodes 10-1 and 11-1 in FIGS. 8 and 9 corresponds to the above-described Expression (11). Further, the process in the FC layer performed at Nodes 10-2 and 11-2 corresponds to the above-described Expression (12), i.e., the MV products and the bias addition. Further, the dividing process performed at Nodes 10-3 and 11-3 corresponds to the above-described Expression (13). Further, the element operation process performed at Nodes 10-4 and 11-4 corresponds to the above-described Expression (14), and the element operation process performed at Nodes 10-5 and 11-5 corresponds to the above-described Expression (15). Therefore, in this case, it can be said that the node decomposing unit 102 divides nodes in the RNN layer into the below-shown first type nodes and second type nodes. That is, in this case, the first type nodes are Nodes 10-2 and 11-2 in the FC layer (fully connected layer) using the identity function as the non-linear activation function. Further, the second type nodes are Connecting Nodes 10-1 and 11-1, which are nodes preceding the nodes in the FC layer and connect data, Dividing Nodes 10-3 and 11-3, which are nodes subsequent to the nodes in the FC layer and divide data, and element operation Nodes 10-4, 11-4, 10-5 and 11-5, which are nodes subsequent to the dividing nodes and perform a predetermined operation.

A converted node will be described hereinafter in detail. Note that the converted node obtained by converting Node 10 in the LSTM layer shown in FIGS. 6 and 7 will be described, and the description of the converted node obtained by converting Node 11 in the LSTM layer, which can be described in a similar manner, will be omitted as appropriate. Node 10-1 is a node to which a part of the input to Node 10 in the LSTM layer (specifically, two inputs xₜ and hₜ₋₁) is input, and performs a connecting process for connecting input vectors. dim: 0 shown in the parameter of the connecting process in FIG. 8 indicates that the process performed by the node having this parameter is a connecting process for the 0-th dimension. When two input vectors for this node are as follows:

u′∈ [symbol] ^{q},v′∈ [symbol] ^{s}.

the output vector, which is expressed as follows:

y′∈ [symbol] ^{q+s}

is expressed as y′=(u′v′)=(u′₀ . . . , u′_{q-1}, v′₀ . . . , v′ₛ₋₁). In the expressions, q and s are the numbers of elements of u′ and v′, respectively, and they are equal to each other and are both 512 (q=s=512) in Nodes 10-1 and 11-1. The connecting process for one dimension or larger, e.g., a connecting process for dim: p′ for the below-shown n′-dimensional input data is a process for connecting elements in a p′-th dimension.

U′∈ [symbol] ^{q}^{₀}^{×q}^{₁}^{× . . . ×q}^{_{n′−1}},V′∈ [symbol] ^{s}^{₀}^{×s}^{₁}^{× . . . ×s}^{_{n′−1}}

When this connecting process is performed, the output data is expressed as follows.

Y′∈ [symbol] ^{q}^{₀}^{×q}^{₁}^{× . . . ×(q}^{_{p′}}^{+s}^{_{p′}}^{)× . . . ×q}^{_{n′−1}}

In the expressions, qⱼ is the number of elements in a j-th dimension of U′, and sⱼ is the number of elements of the j-th dimension of V′. Further, the numbers of elements of U′ and V′ have to be equal to each other except for the p′-th dimension (qⱼ=sⱼ,j=0, . . . , p′−1, p′+1, . . . , n′−1). Note that the following are defined for Node 10-1 shown in FIG. 8 from the structural data of Node 10-1. The input of Node 10-1 is connected to the 0-th output of Node 1 and the 0-th output of Node 2. Further, Node 10-1 generates, by performing the connecting process for the 0-th dimension, output data represented by “0:(1024)” from input data represented by “0:(512), 1:(512)”.

Node 10-2 is a node to which the output of Node 10-1, which performs the connecting process, is input, and performs the process in the FC layer, which uses the identity function as the non-linear activation function, for the input vector. Since Expression (12) is expressed as an FC layer having no activation function fact, the parameter of the FC layer (Nodes 10-2 and 11-2) in FIG. 8 is “f_act: none”. Note that the following are defined for Node 10-2 shown in FIG. 8 from the structural data of Node 10-2. The input of Node 10-2 is connected to the 0-th output of Node 10-1. Further, Node 10-2 performs the process in the FC layer by using a weight designated as weight ID: 1, a bias designated as bias ID: 2, and an activation function which is an identity function. In this way, Node 10-2 generates output data represented by “0:(2048)” from input data represented by “0:(1024)”.

Node 10-3 is a node to which the output of Node 10-2, which performs the process in the FC layer, is input, and performs a dividing process for the output of Node 10-2. dim: 0 shown in the parameter of the dividing process in FIG. 8 indicates that the process performed by the node having this parameter is a dividing process for the 0-th dimension. The dividing process is a reverse process of the connecting process, and the dividing process of dim: p′ is a process for dividing the elements in a p′-th dimension. Note that the following are defined for Node 10-3 shown in FIG. 8 from the structural data of Node 10-3. The input of Node 10-3 is connected to the 0-th output of Node 10-2. Further, Node 10-3 generates output data represented by “0:(512), 1:(512), 2:(512) and 3:(512)” from input data represented by “0:(2048)” by performing a dividing process for the 0-th dimension.

Node 10-4 is a node to which a part of the output of Node 10-3, which performs the dividing process, and a part of the input to Node 10 in the LSTM layer (Specifically, cₜ₋₁) are input, and performs an element operation f_{ew1}. Further, Node 10-5 is a node to which a part of the output of Node 10-4, which performs the element operation f_{ew1}, and a part of the output of Node 10-3, which performs the dividing process, are input, and performs an element operation f_{ew2}. Note that the following are defined for Node 10-4 shown in FIG. 8 from the structural data of Node 10-4. The input of Node 10-4 is connected to the 0-th output of Node 10-3, the first output of Node 10-3, the second output of Node 10-3, and the 0-th output of the node 3. Further, Node 10-4 generates output data represented by “0:(512)” from input data represented by “0:(512), 1:(512), 2:(512) and 3:(512)” by performing the element operation f_{ew1}. Further, the following are defined for Node 10-5 shown in FIG. 8 from the structural data of Node 10-5. The input of Node 10-5 is connected to the 0-th output of Node 10-4 and the third output of Node 10-3. Further, Node 10-5 generates output data represented by “0:(512)” from input data represented by “0:(512) and 1:(512)” by performing the element operation f_{ew2}. Note that when an operator into which a plurality of processes are combined, such as the element operations f_{ew1} and f_{ew2}, cannot be used, the nodes may be further divided into finer operators such as a sigmoid function or a product for each element.

The MV product conversion unit 103 converts the plurality of extracted nodes into nodes in a convolutional layer. However, when a decomposing process is performed for the plurality of extracted nodes by the node decomposing unit 102, the MV product conversion unit 103 converts the decomposed nodes into nodes in a convolutional layer. More specifically, the MV product conversion unit 103 replaces the L nodes in the FC layer that satisfies Conditions 1 to 3 with nodes of a single MM product (i.e., nodes in a convolutional layer). Further, the MV product conversion unit 103 replaces the nodes of MV products and the bias addition, obtained by performing the decomposing process for the L nodes in the RNN layer (LSTM layer) that satisfy Conditions 1 to 3 with nodes of a single MM product (i.e., nodes in a convolutional layer).

When L nodes in the FC layer are extracted by the node extraction unit 101, the MV product conversion unit 103 specifically replaces the L nodes in the FC layer, represented by Expression (10) with nodes in a single convolutional layer having a kernel size k=1, which can be represented by the below-shown Expression (16). That is, the MV product conversion unit 103 replaces a group of nodes of MV products by nodes of MM products.

$$\hat{R} [ l ] [ j ] = {f}_{act} ( {\sum }_{n = 0}^{M - 1} F [ j ] [ n ] \cdot \hat{D} [ l ] [ n ] + b [ j ] ) , \\ j = 0 , … , N - 1 , l = 0 , … , L - 1 \qquad 〈 Expression ( 16 ) 〉$$

Note that the below-shown matrix can be defined
\hat{D}
   by the below-shown matrix in which vectors dₗ are vertically arranged.

$$\hat{D} = [ \begin{matrix}{d}_{0} \\ ⋮ \\ {d}_{L - 1}\end{matrix} ]$$

Further, the output vector rₗ satisfies the below-shown expression. rₗ[j]=\hat{R}[l][j]

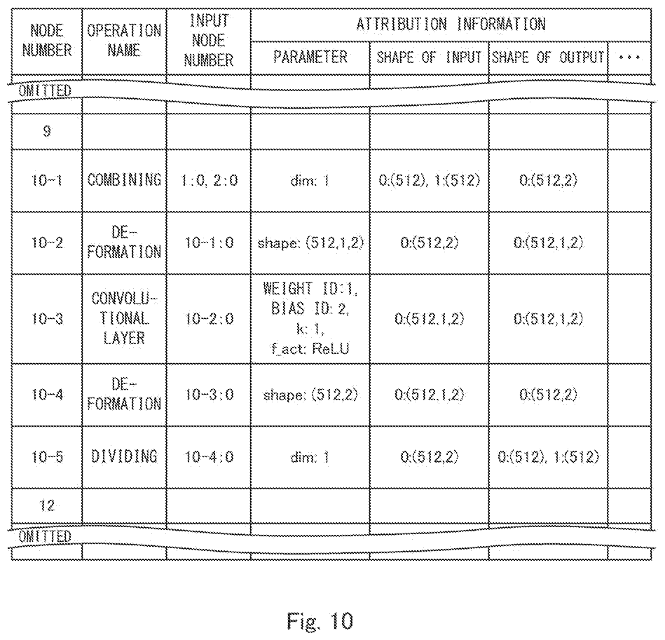

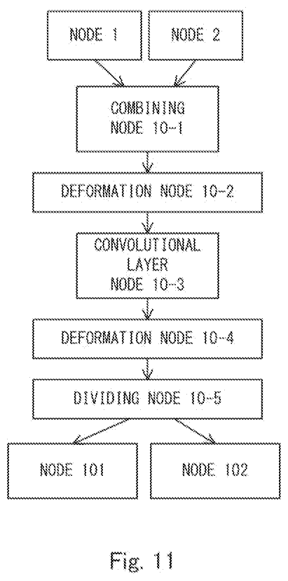

Further, the MV product conversion unit 103 inserts an adjustment node for adjusting a data format in front of (i.e., on the input side of) and behind (i.e., on the output side of) the converted nodes in the convolutional layer. FIG. 10 shows an example of structural data generated by the MV product conversion unit 103 for the neural network from which a set consisting of two FC layers is extracted. FIG. 11 is a schematic diagram showing a connection relationship of nodes represented by the structural data shown in FIG. 10.

The MV product conversion unit 103 converts Nodes 10 and 11 in the FC layer shown in FIGS. 4 and 5 into Node 10-3 in a single convolutional layer. Node 10-3 is a node to which the output of Node 10-2, which performs a shape deformation process (which will be described later), is input, and performs the process in the convolutional layer for the input data. Note that the following are defined for Node 10-3 shown in FIG. 10 from the structural data of Node 10-3. The input of Node 10-3 is connected to the 0-th output of Node 10-2. Further, Node 10-3 performs the process in the convolutional layer having a kernel size of 1 by using a weight designated by the weight ID: 1, a bias designated by the bias ID: 2, and a ReLu function. In this way, Node 10-3 generates output data represented by “0:(512,1,2)” from input data represented by “0:(512,1,2)”.

Further, the MV product conversion unit 103 inserts an adjustment node in front of (i.e., on the input side of) and behind (i.e., on the output side of) Node 10-3 in the convolutional layer. The data format of the input data is adjusted by the aforementioned adjustment node so that it conforms to a data format that Node 10-3 in the convolutional layer requires for the input, and the data format of the output data is adjusted so that it conforms to the data format of the output of the node extracted by the node extraction unit 101. Specifically, as shown in FIGS. 10 and 11, the MV product conversion unit 103 inserts Node 10-1, which performs a combining process, and Node 10-2, which performs a shape deformation process, in front of (i.e., on the input side of) of Node 10-3 in the convolutional layer. Further, the MV product conversion unit 103 inserts Node 10-4, which performs the shape deformation process, and Node 10-5, which performs a dividing process, behind (i.e., on the output side of) Node 10-3 in the convolutional layer.

Node 10-1, which performs the combining process, is a node to which the inputs to Node 10 and the inputs to Node 11 in the FC layer are input, and combines the input vectors. Specifically, this combining process is a process for combining the above-described vector dₗ and outputs the following \hat{D}. The combining process for dim: 1 (the process by Node 10-1) shown in FIG. 10 means that after adding a new dimension to the first dimension, a connecting process of the same parameter dim: 1 is performed. That is, in the combining process designated by the parameter dim: 1, the first dimension is inserted into each of the two vectors having the shape (512): two matrices having the shape (512, 1) are generated: the connecting process for dim: 1 is performed for the two matrices having the shape (512, 1); and one matrix having the shape (512,2) is output. Note that the following are defined for Node 10-1 shown in FIG. 10 from the structural data of Node 10-1. The input of Node 10-1 is connected to the 0-th output of Node 1 and the 0-th output of Node 2. Further, Node 10-1 generates output data represented by “0:(512,2)” from input data represented by “0:(512), 1:(512)” by performing the combining process designated by the parameter dim: 1.

Node 10-2, which performs a shape deformation process, is a node to which the output of Node 10-1, which performs the combining process, is input, and performs the shape deformation process for deforming the input data into 3D input data so as to conform to that of the input in the convolutional layer. In the shape deformation process, the input data is deformed into the shape designated by the parameter “shape”. In the shape deformation process performed by Node 10-2, a matrix having 512 rows and 2 columns is deformed into a tensor having 512 channels, a height of 1, and a width of 2. In the shape deformation process, the number of elements of data having the shape designated by the parameter “shape” has to be equal to the number of elements of the input data of the shape deformation process. In the shape deformation process performed by Node 10-2, the number of elements of the tensor having the shape designated by the parameter “shape: (512,1,2)” is 1,024, which is equal to the number of elements of the input data having the shape (512,2), which is 1,024. Note that the following are defined for Node 10-2 shown in FIG. 10 from the structural data of Node 10-2. The input of Node 10-2 is connected to the 0-th output of Node 10-1. Further, Node 10-2 generates output data represented by “0:(512,1,2)” from input data represented by “0:(512,2)” by performing the shape deformation process designated by the parameter “shape: (512,1,2)”. Note that although the shape of the input data in the convolutional layer is deformed so that it becomes (Number M of input channels, Height H, Width W)=(512,1,2) in the example shown in FIG. 10, it may be deformed in the height direction, i.e., into (512,2,1), or in the case of L>2, may be deformed in both the height and width directions.

Further, subsequent to Node 10-3 in the convolutional layer, Node 10-4, which performs a shape deformation process, and Node 10-5, which performs a dividing process, are added. Node 10-4 is a node to which the output of Node 10-3, which performs the process in the convolutional layer, is input, and deforms the shape of the input data into a predetermined shape. Specifically, Node 10-4 deforms a tensor having 512 channels, a height of 1, and a width of 2 into a matrix having 512 rows and 2 columns. Note that the following are defined for Node 10-4 shown in FIG. 10 from the structural data of Node 10-4. The input of Node 10-4 is connected to the 0-th output of Node 10-3. Further, Node 10-4 generates output data represented by “0:(512,2)” from input data represented by “0:(512,1,2)” by performing the shape deformation process designated by the parameter “shape: (512,2)”.

Node 10-5 is a node to which the output of Node 10-4, which performs the shape deformation process, is input, and performs a dividing process for the output of Node 10-4. Specifically, this dividing process is a process for dividing the above-described \hat{R} and outputting rₗ. Note that the following are defined for Node 10-5 shown in FIG. 10 from the structural data of Node 10-5. The input of Node 10-5 is connected to the 0-th output of Node 10-4. Further, Node 10-5 generates output data represented by “0:(512), 1:(512)” from input data represented by “(512,2)” by performing the dividing process for the first dimension.

As described above, the MV product conversion unit 103 inserts the shape deformation process (Node 10-4) and the dividing process (Node 10-5) so that the shape of the output data of the last node (the shape of the output data of Node 10-5 in FIGS. 10 and 11) becomes the same as the shape of the output of the input structure (the shape of the output data of Nodes 10 and 11 in FIGS. 4 and 5).

When L nodes (i.e., L pieces of nodes) in the RNN layer are extracted by the node extraction unit 101, the MV product conversion unit 103 replaces L nodes of the above-described first type (the nodes of MV products) with nodes in a single convolutional layer which can be expressed by the below-shown Expression (17). That is, the MV product conversion unit 103 replaces the MV product node group with MM product nodes.

$$\hat{M} [ l ] [ j ] = {\sum }_{n = 0}^{P + Q - 1} {F}_{cat} [ j ] [ n ] \cdot \hat{X} [ l ] [ n ] + {b}^{′} [ j ] , \\ j = 0 , … , 4 Q - 1 , l = 0 , … , L - 1 \qquad 〈 Expression ( 17 ) 〉$$

$$\hat{X} = [ \begin{matrix}{x}_{0}^{′} \\ ⋮ \\ {x}_{L - 1}^{′}\end{matrix} ]$$

$${m}_{l} [ j ] = \hat{M} [ l ] [ j ]$$

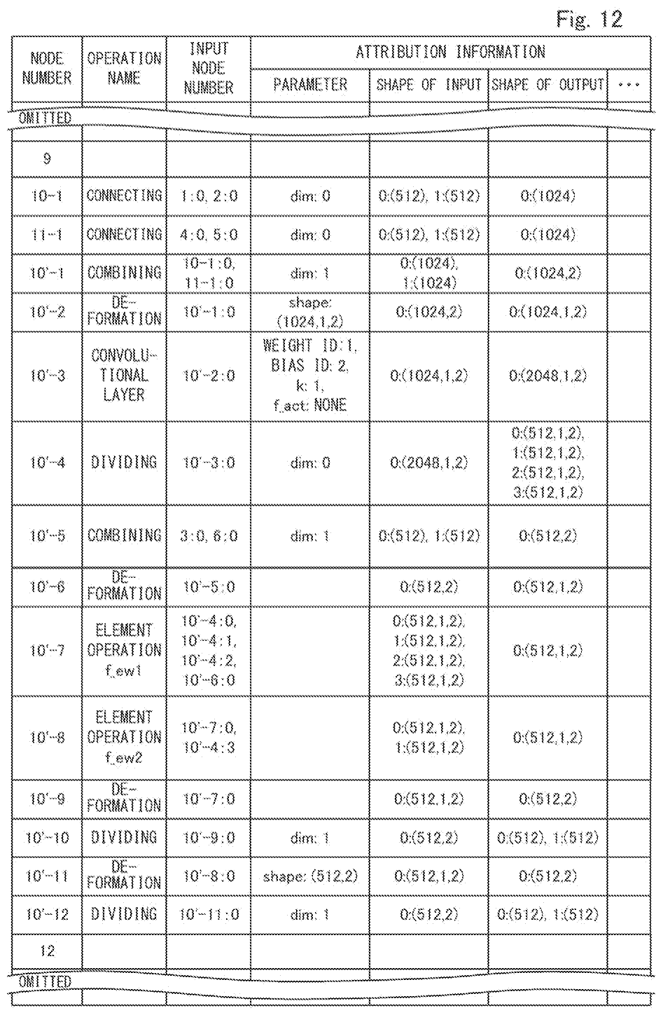

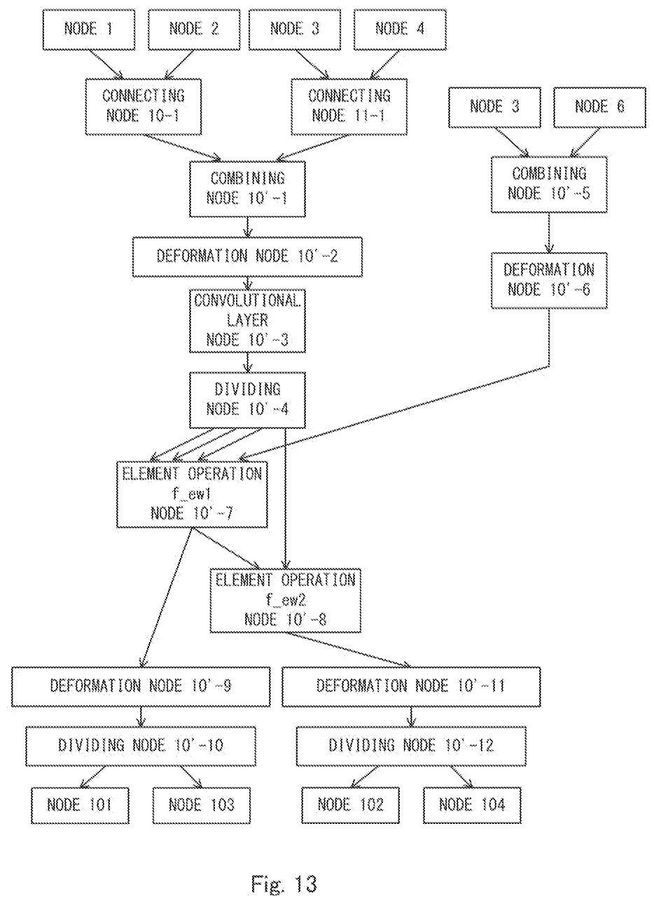

As in the case of the FC layer, the MV product conversion unit 103 inserts an adjustment node for adjusting the data format in front of (i.e., on the input side of) and behind (i.e., on the output side of) the converted nodes in the convolutional layer. FIG. 12 shows an example of structural data generated by the MV product conversion unit 103 for a neural network from which a set consisting of two LSTM layers is extracted. FIG. 13 is a schematic diagram showing a connection relationship of nodes represented by the structural data shown in FIG. 12. Note that numbers assigned to newly added nodes by the MV product conversion unit 103 are selected so as to be different from any of the numbers assigned to the other nodes.

The MV product conversion unit 103 converts Nodes 10-2 and 11-2 in the FC layer shown in FIGS. 8 and 9 into Node 10′-3 in a single convolutional layer. Node 10′-3 is a node into which the output of Node 10′-2, which performs the shape deformation process, is input, and performs the process in the convolutional layer for the input data. Note that the following are defined for Node 10′-3 shown in FIG. 12 from the structural data of Node 10′-3. The input of Node 10′-3 is connected to the 0-th output of Node 10′-2. Further, Node 10′-3 performs the process in the convolutional layer having a kernel size of 1 by using the weight designated by the weight ID: 1, the bias designated by the bias ID: 2, and an activation function which is an identity function. In this way, Node 10′-3 generates output data represented by “0:(2048,1,2)” from input data represented by “0:(1024,1,2)”.

Further, the MV product conversion unit 103 inserts an adjustment node in front of (i.e., on the input side of) and behind (i.e., on the output side of) Node 10′-3 in the convolutional layer. Specifically, as shown in FIGS. 12 and 13, the MV product conversion unit 103 inserts Node 10′-1, which performs a combining process, and Node 10′-2, which performs a shape deformation process, in front of (i.e., on the input side of) of Node 10′-3 in the convolutional layer. Further, the MV product conversion unit 103 inserts Nodes 10′-9 and 10′-11, each of which performs a shape deformation process, and Nodes 10′-10 and 10′-12, each of which performs a dividing process, behind (i.e., on the output side of) Node 10′-3 in the convolutional layer. Node 10′-1 is a node to which the outputs of Nodes 10-1 and 11-1, both of which perform the connecting process, are input, and combines the input vectors. Node 10′-2 is a node to which the output of Node 10′-1, which performs the combining process, is input, and performs a shape deformation process for deforming the input data into 3D input data so as to conform to the input in the convolutional layer. Node 10′-9 is a node to which the output of Node 10′-7, which performs the element operations f_{ew1}, is input, and deforms the input data into a predetermined shape. Similarly, Node 10′-11 is a node to which the output of Node 10′-8, which performs the element operations f_{ew2}, is input, and deforms the input data into the predetermined shape. Further, Node 10′-10 is a node to which the output of Node 10′-9, which performs the shape deformation process, is input, and performs a dividing process for the output of Node 10′-9. Similarly, Node 10′-12 is a node to which the output of Node 10′-11, which performs a shape deformation process, is input, and performs a dividing process for the output data of Node 10′-11.

Further, the MV product conversion unit 103 inserts Node 10′-5, which performs the combining process, and Node 10′-6, which performs the shape deformation process, as adjustment nodes in front of (i.e., on the input side of) of Node 10′-7, which performs the element operation f_{ew1}. The data format is adjusted by these adjustment nodes so that it conforms to the data format that Node 10′-7, which performs the element operation f_{ew1}, requires for the input. Node 10′-5 is a node to which a part of the input to Node 10 in the LSTM layer (specifically, cₜ₋₁) (see FIG. 7) and a part of the input to Node 11 in the LSTM layer (specifically, cₜ₋₁) (see FIG. 7) are input, and combines the input vectors. Node 10′-6 is a node to which the output of Node 10′-5, which performs the combining process, is input, and performs a shape deformation process for deforming the input data so as to conform to the input of Node 10′-7, which performs the element operation f_{ew1}.

Specific processes performed by these nodes are defined based on the structural data for the adjustment nodes shown in FIG. 12. Note that the specific meaning of the structural data shown in FIG. 12 can be understood based on the above description with reference to FIG. 10 in a similar manner, and therefore the description thereof will be omitted.

In the case of the RNN layer, not only the MV products but also element operations can be performed by the common nodes. This is because data derived from nodes in different RNN layers are combined. In order to realize the execution of operations by the common nodes, the MV product conversion unit 103 may express processes of a plurality of dividing nodes derived from nodes in different RNN layers as processes of one node, and may express processes of a plurality of element operation nodes derived from nodes in different RNN layers as processes of one node. Specifically, the MV product conversion unit 103 expresses processes of a plurality of dividing nodes derived from nodes in different RNN layers (i.e., Nodes 10-3 and 11-3 in FIG. 9) as processes of one node (i.e., Node 10′-4 in FIGS. 12 and 13). That is, the MV product conversion unit 103 replaces the process performed by the dividing node for different RNN layers with a common process. Further, the MV product conversion unit 103 expresses processes of a plurality of nodes, which perform the element operation f_{ew1}, derived from different RNN layers (i.e., Nodes 10-4 and 11-4 in FIG. 9) as processes of one node (i.e., Node 10′-7 in FIGS. 12 and 13). That is, the MV product conversion unit 103 replaces the element operation f_{ew1} for different RNN layers with a common process. Further, the MV product conversion unit 103 expresses processes of a plurality of nodes, which perform the element operation f_{ew2}, derived from different RNN layers (i.e., Nodes 10-5 and 11-5 in FIG. 9) as processes of one node (i.e., Node 10′-8 in FIGS. 12 and 13). That is, the MV product conversion unit 103 replaces the element operation f_{ew2} for different RNN layers with a common process.

Node 10′-4 is a node to which the output of Node 10′-3, which performs the process in the convolutional layer, is input, and performs a dividing process for the output of Node 10′-3. Node 10′-4 divides the input data into data for the element operation f_{ew1} and data for the element operation f_{ew2}. Note that the following are defined for Node 10′-4 shown in FIG. 12 from the structural data of Node 10′-4. The input of Node 10′-4 is connected to the 0-th output of Node 10′-3. Further, Node 10′-4 generates output data represented by “0:(512,1,2), 1:(512,1,2), 2:(512,1,2) and 3:(512,1,2)” from input data represented by “0:(2048,1,2)” by performing a dividing process for the 0-th dimension.

Node 10′-7 is a node to which a part of the output of Node 10′-4, which performs the dividing process, and the output of Node 10′-6, which performs the shape deformation process, are input, and performs the element operation f_{ew1}. Further, Node 10′-8 is a node to which the output of Node 10′-7, which performs the element operation f_{ew1}, and a part of the output of Node 10′-4, which performs the dividing process, are input, and performs the element operation f_{ew2}. Note that the following are defined for Node 10′-7 shown in FIG. 12 from the structural data of Node 10′-7. The input of node 10′-7 is connected to the 0-th output of Node 10′-4, the first output of Node 10′-4, the second output of Node 10′-4, and the 0-th output of Node 10′-6. Further, Node 10′-7 generates output data represented by “0:(512,1,2)” from input data represented by “0:(512,1,2), 1:(512,1,2), 2:(512,1,2) and 3:(512,1,2)” by performing the element operation f_{ew1}. Further, the following are defined for Node 10′-8 shown in FIG. 12 from the structural data of Node 10′-8. The input of Node 10′-8 is connected to the 0-th output of Node 10′-7 and the third output of Node 10′-4. Further, Node 10′-8 generates output data represented by “0:(512,1,2)” from input data represented by “0:(512,1,2) and 1:(512,1,2)” by performing the element operation f_{ew2} to.

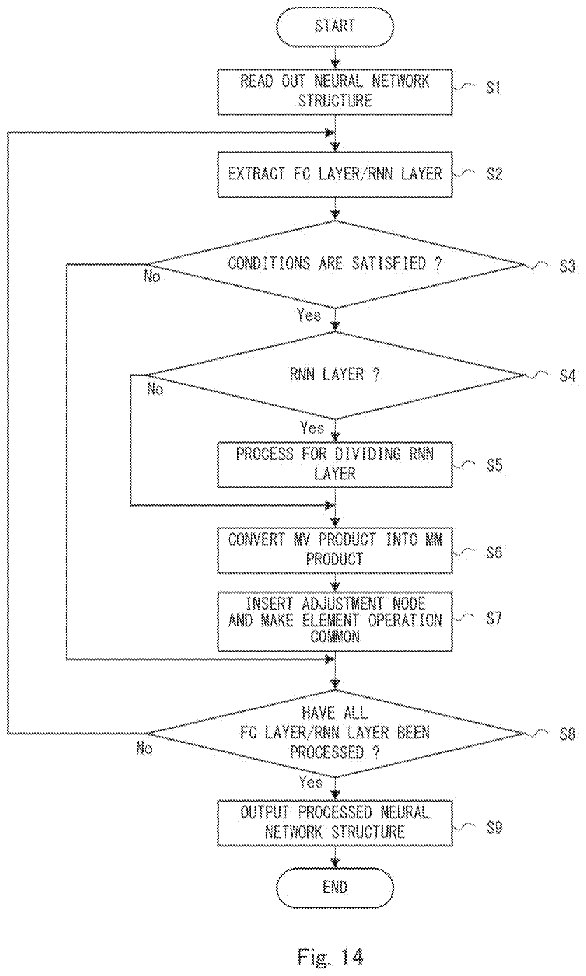

FIG. 14 is a flowchart showing an example of operations performed by the data conversion apparatus 100. A flow of processes performed by components of the above-described data conversion apparatus 100 will be described hereinafter with reference to FIG. 14.

Firstly, in a step S1, a neural network structure is read out. That is, structural data of a neural network to be converted is acquired.

Next, in a step S2, the node extraction unit 101 extracts data in FC layers or RNN layers from the structural data.

Next, in a step S3, the node extraction unit 101 extracts a set of FC layers or a set of RNN layers that satisfy all of the above-described Conditions 1 to 3 from the FC layers or the RNN layers extracted in the step S2. When a set that satisfies all of Conditions 1 to 3 is extracted (Yes in Step S3), the process proceeds to a step S4, and when no such set is extracted (No in Step S3), the process proceeds to a step S8.

In the step S4, the node decomposing unit 102 checks whether or not the set extracted in the step S3 is a set of RNN layers. When the extracted set is a set of RNN layers, the process proceeds to a step S5. When this is not the case, the process in the step S5 is skipped and the process proceeds to a step S6.

In the step S5, the node decomposing unit 102 performs a decomposing process in the RNN layers. After the step S5, the process proceeds to a step S6.

In the step S6, the MV product conversion unit 103 converts nodes of MV products into nodes of MM products.

Further, in a step S7, the MV product conversion unit 103 adds an adjustment node(s) to the structural data. Further, if necessary, the MV product conversion unit 103 modifies the structural data so as to make element operation nodes common. After the step S7, the process proceeds to the step S8.

In the step S8, it is checked whether or not the above-described processes from the steps S2 to S7 have been performed for all the FC layers or RNN layers included in the structure read out in the step S1. When the processes have been performed for all the FC layers or RNN layers, a process in a step S9 is performed. When this is not the case, the above-described processes from the steps S2 to S7 are performed for the remaining FC layers or RNN layers.

In the step S9, the neural network structure in which some of or all MV products are converted to MM products is output. That is, the structural data converted by the data conversion apparatus 100 is output.

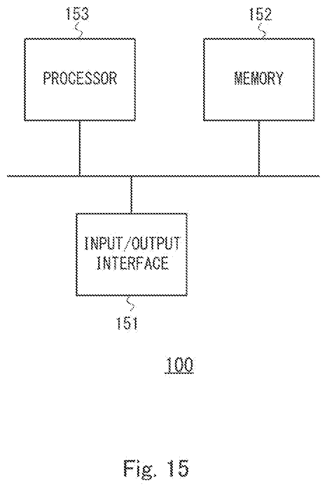

Next, an example of a hardware configuration of the data conversion apparatus 100 will be described. FIG. 15 is a block diagram showing an example of the hardware configuration of the data conversion apparatus 100. As shown in FIG. 15, the data conversion apparatus 100 includes an input/output interface 151, a memory 152, and a processor 153.

The input/output interface 151 is an interface for connecting to other apparatuses so that they can communicate with each other as required.

The memory 152 is composed of, for example, a combination of a volatile memory and a nonvolatile memory. The memory 152 is used to store software (a computer program) including at least one instruction that is executed by the processor 153, and data and like used in various processes.

The processor 153 performs a process performed by each of the above-described components by loading the software (the computer program) from the memory 152 and executes the loaded software. The processor 153 may be, for example, a microprocessor, an MPU (Micro Processor Unit), or a CPU (Central Processing Unit). The processor 153 may include a plurality of processors.

As described above, the data conversion apparatus 100 has functions as a computer.

The program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

According to this example embodiment, the data conversion apparatus 100 performs the above-described processes on structural data of a neural network including layers including MV products, and thereby outputs structural data by which the calculation of MV products can be carried out by performing the calculation of MM products. That is, the data conversion apparatus 100 converts a plurality of MV products in RNN layers or a plurality of MV products in FC layers into MM products, which are operations suitable for an ordinary device that processes a neural network. Therefore, by using the structural data converted by the data conversion apparatus 100, it is possible to process, by such a device, a neural network equivalent to a neural network including layers including MV products at a high speed. In particular, in the conversion by the data conversion apparatus 100, instead of changing a data flow or memory access inside layers, the model structure of the neural network is changed. Therefore, it is possible to process the neural network at a high speed not only by a general-purpose CPU or GPU, but also by an ASIC device. Further, even when the conversion is performed by the data conversion apparatus 100, the equality of the calculation of the neural network is maintained.

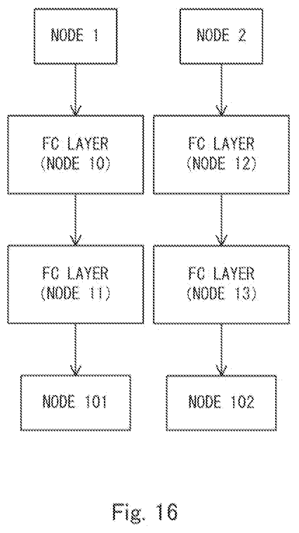

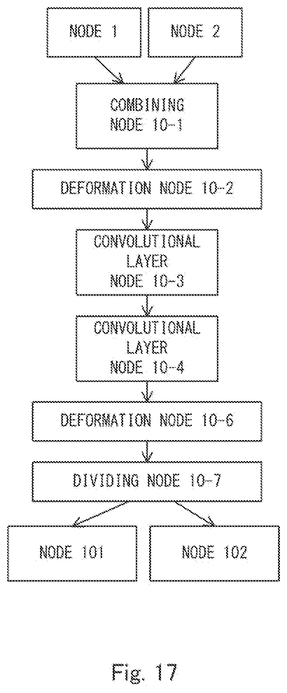

Although the first example embodiment has been described above, various modifications may be made to the above-described example embodiment. For example, as shown in FIGS. 16 and 17, when a set of layers that can be converted into MV products are arranged in series, an intermediate adjustment node(s) may be omitted (i.e., removed), so that the execution time required to process the adjustment node(s) may be reduced. Note that FIG. 16 is a schematic diagram showing an example of a structure of a neural network including a first set of FC layers (Nodes 10 and 12) and a second set of FC layers (Nodes 11 and 13) connected in series with the first set. Further, FIG. 17 is a schematic diagram showing an example of a structure of a neural network converted by the data conversion apparatus 100. Note that Node 10-3 in the convolutional layer shown in FIG. 17 is a node generated by the conversion for the above-described first set, and Node 10-4 in the convolutional layer shown in FIG. 17 is a node generated by the conversion for the above-described second set. Nodes 10-3 and 10-4 are connected in series, and an intermediate adjustment node between them is omitted (i.e., removed). Further, as common adjustment nodes to Nodes 10-3 and 10-4, Node 10-1, which performs a combining process, Node 10-2, which performs a shape deformation process, Node 10-6, which performs a shape deformation process, and Node 10-7, which performs a dividing process, are inserted in front of (i.e., on the input side of) and behind (i.e., on the output side of) Nodes 10-3 and Node 10-4. As described above, when converted nodes in the convolutional layer (i.e., Nodes 10-3 and 10-4 in FIG. 17) are successively arranged in series, the MV product conversion unit 103 may omit (or remove) an intermediate adjustment node(s) by inserting an adjustment node(s) common to the plurality of nodes in convolutional layers, which are successively arranged in series.

### Second Example Embodiment

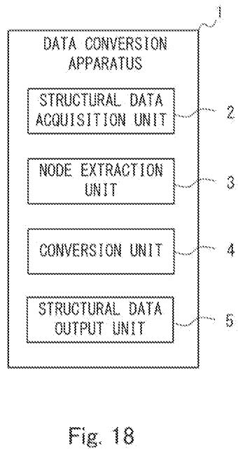

Next, a second example embodiment will be described. The second example embodiment is an example embodiment composed of characteristic elements of the first example embodiment. FIG. 18 is a block diagram showing an example of a configuration of a data conversion apparatus 1 according to the second example embodiment. The data conversion apparatus 1 includes a structural data acquisition unit 2, a node extraction unit 3, a conversion unit 4, and a structural data output unit 5.

The structural data acquisition unit 2 acquires structural data which is data representing the structure of a neural network. The structural data acquisition unit 2 may acquire structural data by reading the structural data from a storage device such as a memory, or may acquire structural data by receiving the structural data from other apparatuses.

The node extraction unit 3 extracts a plurality of nodes for a matrix vector product from the structural data acquired by the structural data acquisition unit 2. Note that the nodes for the matrix vector product are nodes for which processes including the calculation of a matrix vector product is performed, and are, for example, nodes in FC layers or nodes in RNN layers. In particular, the node extraction unit 3 extracts nodes that satisfy predetermined conditions. More specifically, the predetermined conditions are the above-described Conditions 1 to 3. That is, the node extraction unit 3 extracts nodes that satisfy conditions that: the number of elements of inputs of nodes are equal to each other and the number of elements of outputs of the nodes are equal to each other: parameters (weights and bias values) used in the nodes are the same as each other; and there is no dependency between the nodes. Note that the fact that there is no dependency between nodes can be expressed that the calculation result of any of the nodes does not affect the calculation result of any of the other nodes.

The conversion unit 4 converts a plurality of nodes extracted by the node extraction unit 3 into nodes in a convolutional layer. Then, the structural data output unit 5 outputs structural data that has been converted by the conversion unit 4. The structural data output unit 5 may output, for example, the structural data to a storage device such as a memory, or transmit it to other devices (e.g., a device that processes a neural network by using the converted structural data).

According to this example embodiment, it is possible to convert structural data of a neural network including layers including MV products into structural data by which the neural network can be carried out by performing the calculation of MM products, and output the converted structure data. Therefore, it is possible to process a neural network including a layer including MV products at a high speed.

Although the present invention is described above with reference to example embodiments, the present invention is not limited to the above-described example embodiments. Various modifications that can be understood by those skilled in the art can be made to the configuration and details of the present invention within the scope and spirit of the invention.

The whole or part of the example embodiments disclosed above can be described as, but not limited to, the following supplementary notes.

### (Supplementary Note 1)

A data conversion apparatus comprising:
structural data acquisition means for acquiring structural data representing a structure of a neural network;
node extraction means for extracting a plurality of nodes for a matrix vector product from the structural data;
conversion means for converting the extracted plurality of nodes into nodes in a convolutional layer; and
structural data output means for outputting the converted structural data.

### (Supplementary Note 2)

The data conversion apparatus described in Supplementary note 1, wherein the node extraction means extracts the nodes satisfying conditions that: the numbers of elements of inputs of the nodes are equal to each other: the numbers of elements of outputs of the nodes are equal to each other: parameters used in the nodes are the same as each other; and there is no dependency between the nodes.

### (Supplementary Note 3)

The data conversion apparatus described in Supplementary note 2, wherein the conversion means inserts an adjustment node for adjusting a data format in front of and behind the converted node in the convolutional layer.

### (Supplementary Note 4)

The data conversion apparatus described in Supplementary note 3, wherein when the converted nodes in the convolutional layer are successively arranged in series, the conversion means inserts the adjustment node common to the plurality of nodes in the convolutional layers successively arranged in series.

### (Supplementary Note 5)

The data conversion apparatus described in any one of Supplementary notes 1 to 4, wherein the node extraction means extracts a node in a fully connected layer as a node for a matrix vector product.

### (Supplementary Note 6)

The data conversion apparatus described in any one of Supplementary notes 1 to 5, wherein
the node extraction means extracts a node in an RNN (Recurrent Neural Network) layer as a node for a matrix vector product,
the data conversion device further comprises decomposing means for decomposing the extracted node in the RNN layer into a node of a first type and a node of a second type, the node of the first type being a node of a matrix vector product, and the node of the second type being a node other than the matrix vector product, and
the conversion means converts a plurality of nodes of the first type into nodes in the convolutional layer.

### (Supplementary Note 7)

The data conversion apparatus described in Supplementary note 6, wherein
the node of the first type is a node in a fully connected layer using an identity function as a non-linear activation function, and
the node of the second type is a connecting node, a dividing node, or an element operation node, the connecting node being a node disposed in front of the node in the fully connected layer and connecting data, the dividing node being a node disposed behind the node in the fully connected layer and dividing the data, and the element operation node being a node disposed behind the dividing node and performing a predetermined operation.

### (Supplementary Note 8)

The data conversion apparatus described in Supplementary note 7, wherein the conversion means expresses a process of the plurality of dividing nodes derived from nodes in different RNN layers as a process of one node, and expresses a process of the plurality of element operation nodes derived from the nodes in the different RNN layers as a process of one node.

### (Supplementary Note 9)

A data conversion method comprising:
acquiring structural data representing a structure of a neural network;
extracting a plurality of nodes for a matrix vector product from the structural data;
converting the extracted plurality of nodes into nodes in a convolutional layer; and
outputting the converted structural data.

### (Supplementary Note 10)

A non-transitory computer readable medium storing a program for causing a computer to perform:
a step of acquiring structural data representing a structure of a neural network;
a step of extracting a plurality of nodes for a matrix vector product from the structural data;
a step of converting the extracted plurality of nodes into nodes in a convolutional layer; and
a step of outputting the converted structural data.

### REFERENCE SIGNS LIST

1 DATA CONVERSION APPARATUS
2 STRUCTURAL DATA ACQUISITION UNIT
3 NODE EXTRACTION UNIT
4 CONVERSION UNIT
5 STRUCTURAL DATA OUTPUT UNIT
91 STRUCTURAL DATA
92 STRUCTURAL DATA
100 DATA CONVERSION APPARATUS
101 NODE EXTRACTION UNIT
102 NODE DECOMPOSING UNIT
103 MV PRODUCT CONVERSION UNIT
151 INPUT/OUTPUT INTERFACE
152 MEMORY
153 PROCESSOR

What is claimed is:

1. A data conversion apparatus comprising:
at least one memory storing instructions; and
at least one processor configured to execute the instructions to:
acquire structural data representing a structure of a neural network;
extract a plurality of nodes for a matrix vector product from the structural data;
convert the extracted plurality of nodes into nodes in a convolutional layer; and
output the converted structural data.

2. The data conversion apparatus according to claim 1, wherein the processor is further configured to execute the instructions to extract the nodes satisfying conditions that: the numbers of elements of inputs of the nodes are equal to each other; the numbers of elements of outputs of the nodes are equal to each other; parameters used in the nodes are the same as each other; and there is no dependency between the nodes.

3. The data conversion apparatus according to claim 2, wherein the processor is further configured to execute the instructions to insert an adjustment node for adjusting a data format in front of and behind the converted node in the convolutional layer.

4. The data conversion apparatus according to claim 3, wherein the processor is further configured to execute the instructions to insert, when the converted nodes in the convolutional layer are successively arranged in series, the adjustment node common to the plurality of nodes in the convolutional layers successively arranged in series.

5. The data conversion apparatus according to claim 1, wherein the processor is further configured to execute the instructions to extract a node in a fully connected layer as a node for a matrix vector product.

6. The data conversion apparatus according to claim 1, wherein the processor is further configured to execute the instructions to:
extract a node in an RNN (Recurrent Neural Network) layer as a node for a matrix vector product,
decompose the extracted node in the RNN layer into a node of a first type and a node of a second type, the node of the first type being a node of a matrix vector product, and the node of the second type being a node other than the matrix vector product, and
convert a plurality of nodes of the first type into nodes in the convolutional layer.

7. The data conversion apparatus according to claim 6, wherein
the node of the first type is a node in a fully connected layer using an identity function as a non-linear activation function, and
the node of the second type is a connecting node, a dividing node, or an element operation node, the connecting node being a node disposed in front of the node in the fully connected layer and connecting data, the dividing node being a node disposed behind the node in the fully connected layer and dividing the data, and the element operation node being a node disposed behind the dividing node and performing a predetermined operation.

8. The data conversion apparatus according to claim 7, wherein the processor is further configured to execute the instructions to express a process of the plurality of dividing nodes derived from nodes in different RNN layers as a process of one node, and express a process of the plurality of element operation nodes derived from the nodes in the different RNN layers as a process of one node.

9. A data conversion method comprising:
acquiring structural data representing a structure of a neural network;
extracting a plurality of nodes for a matrix vector product from the structural data;
converting the extracted plurality of nodes into nodes in a convolutional layer; and
outputting the converted structural data.

10. A non-transitory computer readable medium storing a program for causing a computer to perform:
a step of acquiring structural data representing a structure of a neural network;
a step of extracting a plurality of nodes for a matrix vector product from the structural data;
a step of converting the extracted plurality of nodes into nodes in a convolutional layer; and
a step of outputting the converted structural data.
